(19) United States
(12) Patent Application Publication
(10) Pub. No.: US 2007/0192673 A1
(43) Pub. Date: Aug. 16, 2007

(54) Annotating an audio file with an audio hyperlink

(76) Inventors: William K. Bodin, Austin, TX (US); David Jaramillo, Lake Worth, FL (US); Jerry W. Redman, Cedar Park, TX (US); Derral C. Thorson, Austin, TX (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/352,710

(22) Filed: Feb. 13, 2006

(51) Int. Cl. G06F 17/00

(52) U.S. Cl. 715/500.1; 715/512

(57) ABSTRACT

Methods, systems, and computer program products are provided for annotating an audio file with an audio hyperlink. Embodiments include receiving an identification of a playback time in an audio file to associate with an audio hyperlink; receiving a selection of a Uniform Resource Identifier (‘URI’) identifying a resource to be accessed upon the invocation of the audio hyperlink; receiving a selection of one or more keywords for invoking the audio hyperlink; and associating with the playback time in the audio file the URI, and the one or more keywords. Typical embodiments also include receiving a selection of an audio indication type for identifying of the existence of the audio hyperlink during playback of the audio file and associating with the playback time in the audio file the URI, and the one or more keywords further comprises associating with the playback time the audio indication.

### BACKGROUND OF THE INVENTION

1. Field of the Invention

The field of the invention is data processing, or, more specifically, methods, systems, and products for annotating an audio file with an audio hyperlink.

2. Description Of Related Art

A ‘hyperlink’ is a reference to a URI which when invoked requests access to a resource identified by a URI. The term ‘hyperlink’ often includes links to URIs effected through conventional markup elements for visual display, as well as ‘Back’ and ‘Forward’ buttons on a toolbar in a GUI of a software application program. Users are typically made aware of hyperlinks by displaying text associated with the hyperlink or the URI itself in highlighting, underscoring, specially coloring, or some other fashion setting the hyperlink apart from other screen text and identifying it as an available hyperlink. In addition, the screen display area of the anchor is often sensitized to user interface operations such as GUI pointer operations such as mouse clicks. Such conventional hyperlinks require a visual screen display to make a user aware of the hyperlink and a device for GUI pointer operations to invoke the hyperlink. Audio files however are typically played on devices with no visual display and without devices for GUI pointer operations.

### SUMMARY OF THE INVENTION

Methods, systems, and computer program products are provided for annotating an audio file with an audio hyperlink. Embodiments include receiving an identification of a playback time in an audio file to associate with an audio hyperlink; receiving a selection of a Uniform Resource Identifier (‘URI’) identifying a resource to be accessed upon the invocation of the audio hyperlink; receiving a selection of one or more keywords for invoking the audio hyperlink; and associating with the playback time in the audio file the URI, and the one or more keywords. Typical embodiments also include receiving a selection of an audio indication type for identifying of the existence of the audio hyperlink during-playback of the audio file and associating with the playback time in the audio file the URI, and the one or more keywords further comprises associating with the playback time the audio indication.

Receiving an identification of a playback time in an audio file to associate with an audio hyperlink may be carried out by receiving a user instruction during the recording of the audio file. Receiving an identification of a playback time in an audio file to associate with an audio hyperlink may also be carried out by receiving a user instruction after the recording of the audio file.

Associating with the playback time in the audio file the URI and the one or more keywords may be carried out by creating an audio hyperlink data structure including an identification of the playback time, a grammar, and an URI. Associating with the playback time in the audio file the URI and the one or more keywords may also be carried out by creating an audio hyperlink markup document including an identification of the playback time, a grammar, and a URI.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram illustrating an exemplary system of computers each of which is capable of invoking an audio hyperlink according to the present invention and for annotating an audio file with an audio hyperlink according to the present invention.

FIG. 2 sets forth a line drawing of an exemplary audio file player capable of invoking an audio hyperlink according to the present invention.

FIG. 3 sets forth a block diagram of automated computing machinery comprising an exemplary computer useful in both invoking an audio hyperlink according to the present invention and annotating an audio file with an audio hyperlink according to the present invention.

FIG. 4 sets forth a flow chart illustrating an exemplary method for invoking an audio hyperlink.

FIG. 5 sets forth a flow chart illustrating an exemplary method for playing an audio indication of an audio hyperlink.

FIG. 6 sets forth a flow chart illustrating an exemplary method for receiving from a user an instruction to invoke the audio hyperlink.

FIG. 7 sets forth a flow chart illustrating an exemplary method for identifying a URI associated with the audio hyperlink.

FIG. 8 sets forth a flow chart illustrating an exemplary method for annotating an audio file with an audio hyperlink.

FIG. 9 sets forth a flow chart illustrating another exemplary method for annotating an audio file with an audio hyperlink.

FIG. 10 sets forth a line drawing of an audio hyperlink file annotation tool useful in annotating an audio file with an audio hyperlink according to the present invention.

### DETAILED DESCRIPTION OF EXEMPLARY EMBODIMENTS

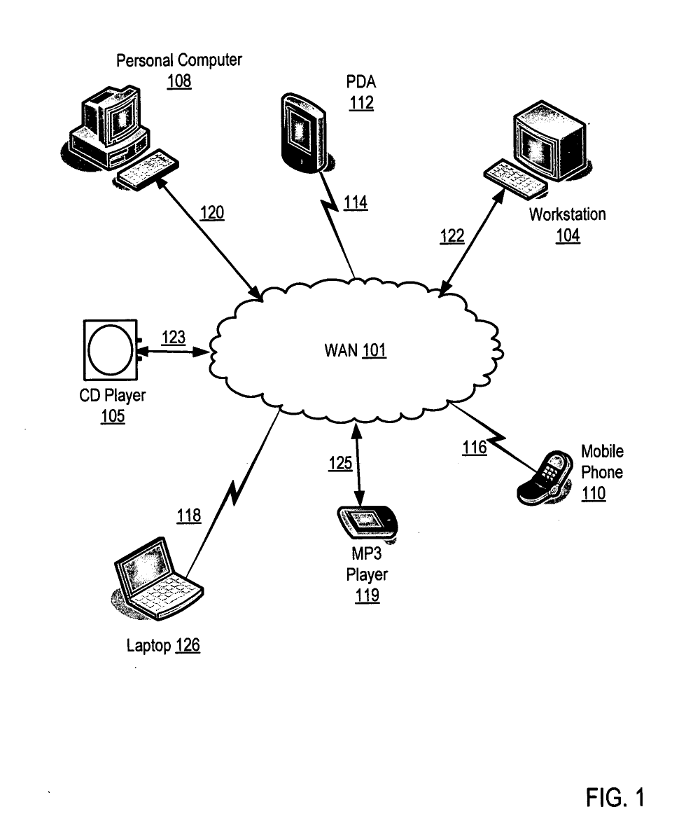

Exemplary methods, systems, and products for invoking an audio hyperlink and for annotating an audio file with an audio hyperlink according to embodiments of the present invention are described with reference to the accompanying drawings, beginning with FIG. 1. FIG. 1 sets forth a network diagram illustrating an exemplary system of computers each of which is capable of invoking an audio hyperlink according to the present invention and for annotating an audio file with an audio hyperlink according to the present invention. In the example of FIG. 1 a personal computer (108) is connected to a wide are network (‘WAN’) (101) though a wireline connection (120). A PDA (112) connects to the WAN (101) through a wireless connection (114). A workstation (104) connects to the WAN (101) through a wireline connection (122). A mobile phone (110) connects to the WAN (101) through a wireless connection (116). An MP3 audio file player (119) connects to the WAN (101) through a wireline connection (125). A laptop (126) connects-to the WAN (101) through a wireless connection (118). A compact disc player (105) connects to the WAN (101) through a wireline connection (123).

Each of the computers (108, 112, 104, 110, 119, 126, 105) of FIG. 1 is capable of playing an audio file and is capable of supporting an audio file player according the present invention that is capable supporting an audio hyperlink module computer program instructions for invoking an audio hyperlink. Such an audio hyperlink module is generally capable of identifying a predetermined playback time in an audio file pre-designated as having an associated audio hyperlink; playing an audio indication of the audio hyperlink at the predetermined playback time; receiving from a user an instruction to invoke the audio hyperlink; identifying a URI associated with the audio hyperlink; and invoking the URI.

An ‘audio hyperlink’ is a reference to a URI which when invoked requests access to a resource identified by the URI and whose existence is identified to users through an audio indication of the audio hyperlink. Audio hyperlinks according to the present invention are typically invoked through speech by a user, although audio hyperlinks may also be invoked by user through an input device such as a keyboard, mouse or other device as will occur to those of skill in the art.

A “URI” or “Uniform Resource Identifier” is an identifier of an object. Such an object may be in any namespace accessible through a network, a file accessible by invoking a filename, or any other object as will occur to those of skill in the art. URIs are functional for any access scheme, including for example, the File Transfer Protocol or “FTP,” Gopher, and the web. A URI as used in typical embodiments of the present invention usually includes an internet protocol address, or a domain name that resolves to an internet protocol address, identifying a location where a resource, particularly a web page, a CGI script, or a servlet, is located on a network, usually the Internet. URIs directed to particular resources, such as particular HTML files, JPEG files, or MPEG files, typically include a path name or file name locating and identifying a particular resource in a file system coupled to a network. To the extent that a particular resource, such as a CGI file or a servlet, is executable, for example to store or retrieve data, a URI often includes query parameters, or data to be stored, in the form of data encoded into the URI. Such parameters or data to be stored are referred to as ‘URI encoded data.’

Each of the computers (108, 112, 104, 110, 119, 126, 105) of FIG. 1 is capable of supporting an audio file annotation tool comprising computer program instructions for annotating an audio file with an audio hyperlink. Such an audio file annotation tool is generally capable of receiving an identification of a playback time in an audio file to associate with an audio hyperlink; receiving a selection of a URI identifying a resource to be accessed upon the invocation of the audio hyperlink; receiving a selection of one or more keywords for invoking the audio hyperlink; and associating with the playback time in the audio file the URI, and the one or more keywords.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

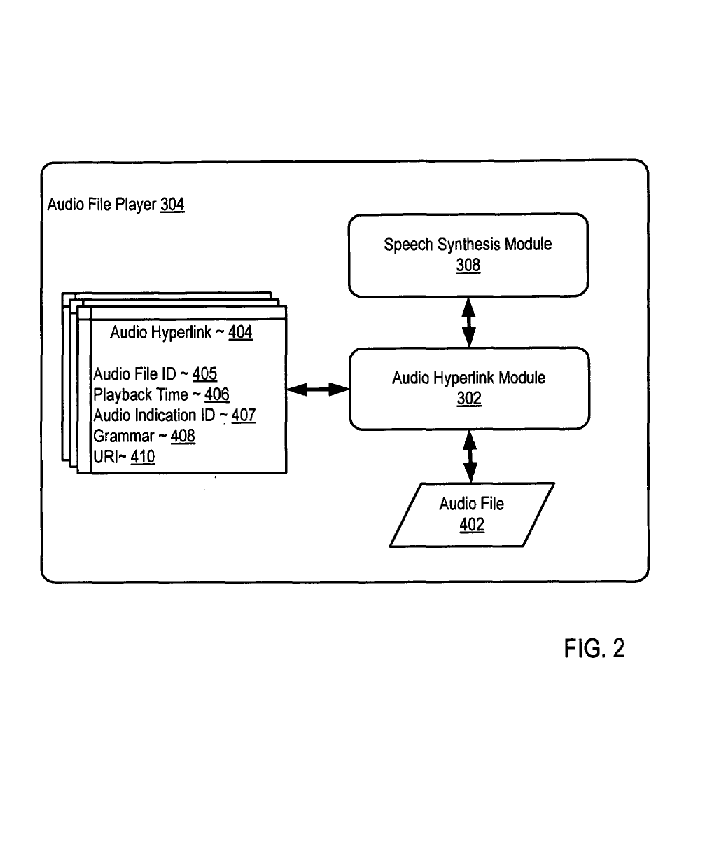

For further explanation, FIG. 2 sets forth a line drawing of an exemplary audio file player (304) capable of invoking an audio hyperlink according to the present invention. An ‘audio hyperlink’ is a reference to a URI which when invoked requests access to a resource identified by the URI and whose existence is identified to users through an audio indication of the audio hyperlink. Audio hyperlinks according to the present invention are typically invoked through speech by a user, although audio hyperlinks may also be invoked by user through an input device such as a keyboard, mouse or other device as will occur to those of skill in the art.

The audio file player (304) of FIG. 2 also includes a speech synthesis module (308), computer program instructions capable of receiving speech from a user, converting the speech to text, and comparing the text to a grammar to receive an instruction as speech from a user to invoke the audio hyperlink. Examples of speech synthesis modules useful in invoking audio hyperlinks according to the present invention include IBM's Via Voice Text-to-Speech, Acapela Multimedia TTS, AT&T Natural Voices™ Text-to-Speech Engine, and other speech synthesis modules as will occur to those of skill in the art.

The audio file player (304) of FIG. 2 includes an audio hyperlink module, computer program instructions for identifying a predetermined playback time in an audio file (402) pre-designated as having an associated audio hyperlink, playing an audio indication of the audio hyperlink at the predetermined playback time; receiving from a user an instruction to invoke the audio hyperlink; identifying a URI associated with the audio hyperlink; and invoking the URI.

Audio files useful in invoking audio hyperlinks and capable of being annotated with audio hyperlinks according to the present invention include audio files, as well as audio subcomponents of a file also including video. Examples of audio files useful with the present invention include wave files ‘.wav’, MPEG layer-3 files (‘.mp3’) and others as will occur to those of skill in the art.

The audio hyperlink in the example of FIG. 2 is implemented as a data structure (404) made available to the audio hyperlink module (302) in an audio file player (304). The audio hyperlink data structure (404) of FIG. 2 includes an audio file ID (405) uniquely identifying the audio file having an associated audio hyperlink. The audio hyperlink data structure (404) of FIG. 2 also includes a playback time (406) identifying a playback time in the audio file having an associated audio hyperlink.

The audio hyperlink data structure (404) of FIG. 2 includes an audio indication ID (407) uniquely identifying the audio indication for the audio hyperlink. An audio indication is a predetermined sound for augmenting the playback of the audio file that is designed to make a user aware of the existence of the audio hyperlink. Audio indications may be predetermined earcons designed to inform users of the existence of audio hyperlinks, pitch-shifts or phase-shifts during the playback of the audio file designed to inform users of the existence of audio hyperlinks or any other audio indication that will occur to those of skill in the art. An audio player supporting more than one type of audio indication of audio hyperlinks in audio files may be informed of one of a plurality of supported audio indications through the use of an audio indication ID (407) in an audio hyperlink data structure (404) as in the example of FIG. 2.

The audio hyperlink data structure (404) of FIG. 2 includes a grammar (408). A grammar is a collection of one or more keywords that are recognized by an audio player supporting audio files with audio hyperlinks that when received trigger the invocation of URI for the audio hyperlink. The audio hyperlink data structure (404) of FIG. 2 also includes a URI (410) identifying a resource referenced by the audio hyperlink. The URI identifies a resource accessed by invoking the audio hyperlink.

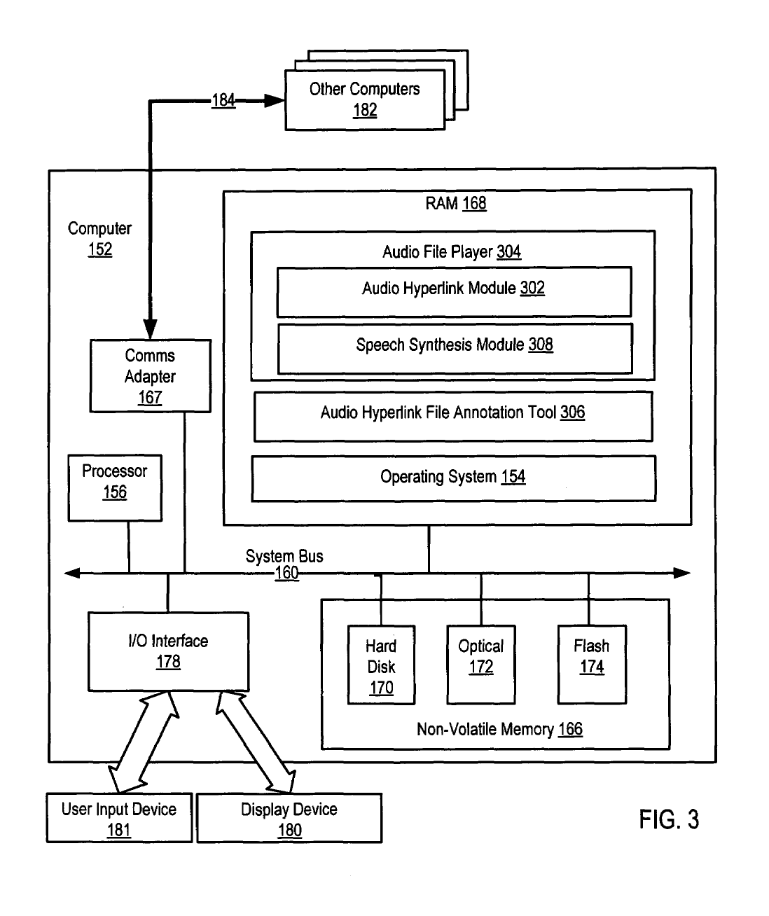

Invoking an audio hyperlink and annotating an audio file with an audio hyperlink in accordance with the present invention is generally implemented with computers, that is, with automated computing machinery. In the system of FIG. 1, for example, all the nodes, servers, and communications devices are implemented to some extent at least as computers. For further explanation, therefore, FIG. 3 sets forth a block diagram of automated computing machinery comprising an exemplary computer (152) useful in both invoking an audio hyperlink according to the present invention and annotating an audio file with an audio hyperlink according to the present invention. The computer (152) of FIG. 3 includes at least one computer processor (156) or ‘CPU’ as well as random access memory (168) (‘RAM’) which is connected through a system bus (160) to processor (156) and to other components of the computer. Stored in RAM (168) is an audio file player (304) including an audio hyperlink module (302), computer program instructions for invoking an audio hyperlink that are capable of identifying a predetermined playback time in an audio file pre-designated as having an associated audio hyperlink; playing an audio indication of the audio hyperlink at the predetermined playback time; receiving from a user an instruction to invoke the audio hyperlink; identifying a URI associated with the audio hyperlink; and invoking the URI.

The audio file player (304) of FIG. 3 also includes a speech synthesis module (308), computer program instructions capable of receiving speech from a user, converting the speech to text, and comparing the text to a grammar to receive an instruction as speech from a user to invoke the audio hyperlink. Examples of speech synthesis modules useful in invoking audio hyperlinks according to the present invention include IBM's ViaVoice Text-to-Speech, Acapela Multimedia TTS, AT&T Natural Voices™ Text-to-Speech Engine, and other speech synthesis modules as will occur to those of skill in the art.

Also stored RAM (168) is an audio hyperlink file annotation tool (306) computer program instructions for annotating an audio file with an audio hyperlink that are capable of receiving an identification of a playback time in an audio file to associate with an audio hyperlink; receiving a selection of a Uniform Resource identifier (‘URI’) identifying a resource to be accessed upon the invocation of the audio hyperlink; receiving a selection of one or more keywords for invoking the audio hyperlink; and associating with the playback time in the audio file the URI, and the one or more keywords. Also stored in RAM (168) is an operating system (154). Operating systems useful in computers according to embodiments of the present invention include UNIX™, Linux™, Microsoft XP™, AIX™, IBM's i5/OS™, and others as will occur to those of skill in the art. Operating system (154), audio file player (304), audio hyperlink module (302), speech synthesis module (308) and audio hyperlink annotation tool (306) in the example of FIG. 3 are shown in RAM (168), but many components of such software typically are stored in non-volatile memory (166) also.

Computer (152) of FIG. 3 includes non-volatile computer memory (166) coupled through a system bus (160) to processor (156) and to other components of the computer (152). Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The example computer of FIG. 3 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

The exemplary computer (152) of FIG. 3 includes a communications adapter (167) for implementing data communications (184) with other computers (182). Such data communications may be carried out serially through RS-232 connections, through external buses such as USB, through data communications networks such as IP networks, and in other ways as will occur to those of skill in the art. Communications adapters implement the hardware level of data communications through which one computer sends data communications to another computer, directly or through a network. Examples of communications adapters useful for determining availability of a destination according to embodiments of the present invention include modems for wired dial-up communications, Ethernet (IEEE 802.3) adapters for wired network communications, and 802.11b adapters for wireless network communications.

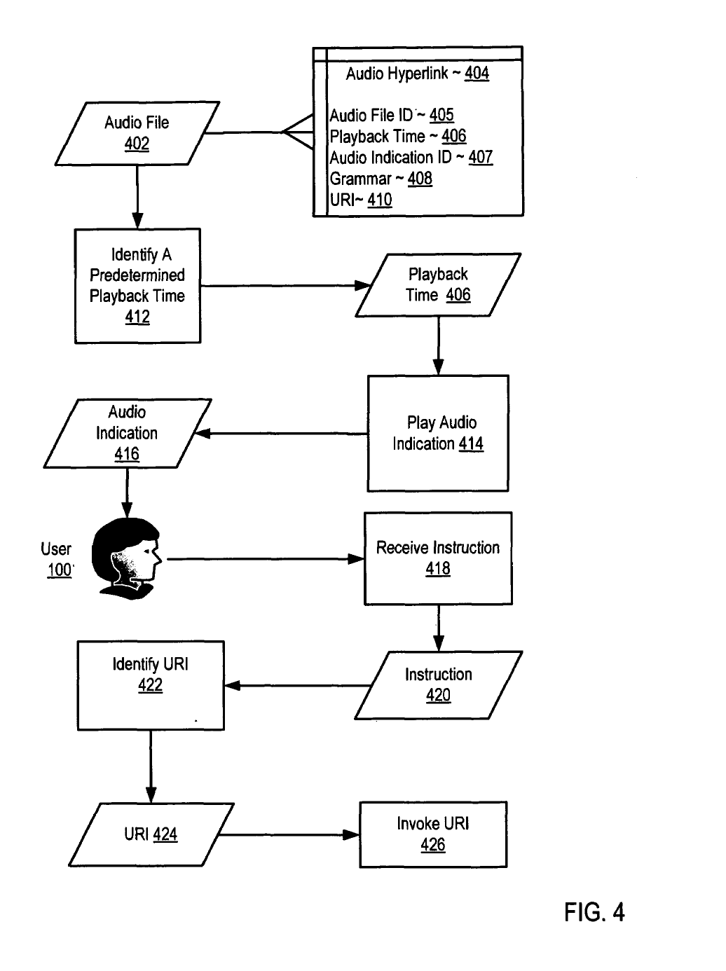

For further explanation, FIG. 4 sets forth a flow chart illustrating an exemplary method for invoking an audio hyperlink. As discussed above, an ‘audio hyperlink’ is a reference to a URI which when invoked requests access to a resource identified by the URI and whose existence is identified to users through an audio indication of the audio hyperlink. Audio hyperlinks according to the present invention are typically invoked through speech by a user, although audio hyperlinks may also be invoked by user through an input device such as a keyboard, mouse or other device as will occur to those of skill in the art. Audio files useful in invoking audio hyperlinks and being capable of being annotated with audio hyperlinks according to the present invention include audio files, as well as audio subcomponents of a file also including video.

The audio hyperlink in the example of FIG. 4 is implemented as a data structure (404) made available to an audio hyperlink module in an audio file player. The audio hyperlink data structure (404) of FIG. 4 includes an audio file ID (405) uniquely identifying the audio file having an associated audio hyperlink. The audio hyperlink data structure (404) of FIG. 4 also includes a playback time (406) identifying a playback time in the audio file having an associated audio hyperlink.

The audio hyperlink data structure (404) of FIG. 4 includes an audio indication ID (407) uniquely identifying the audio indication for the audio hyperlink. An audio indication is a predetermined sound for augmenting the playback of the audio file that is designed to make a user aware of the existence of the audio hyperlink. Audio indications may be predetermined earcons designed to inform users of the existence of audio hyperlinks, pitch-shifts or phase-shifts during the playback of the audio file designed to inform users of the existence of audio hyperlinks or any other audio indication that will occur to those of skill in the art. An audio player supporting more than one type of audio indication of audio hyperlinks in audio files may be informed of one of a plurality of supported audio indications through the use of an audio indication ID (407) in an audio hyperlink data structure (404) as in the example of FIG. 4.

The audio hyperlink data structure (404) of FIG. 4 includes a grammar (408). A grammar is a collection of one or more keywords that are recognized by an audio player supporting audio files with audio hyperlinks that when received trigger the invocation of URI (410) for the audio hyperlink. The audio hyperlink data structure (404) of FIG. 4 also includes a URI identifying a resource referenced by the audio hyperlink. The URI identifies a resource accessed by invoking the audio hyperlink.

The method of FIG. 4 includes identifying (412) a predetermined playback time (406) in an audio file (402) pre-designated as having an associated audio hyperlink (404). Identifying (412) a predetermined playback time (406) in an audio file (402) pre-designated as having an associated audio hyperlink may be carried out by retrieving from an audio hyperlink data structure (404) a playback time (406) in the audio file (402) pre-designated as having an audio hyperlink (404).

The playback time (406) may be targeted to the playback of a single word, phrase, or sound that is conceptually related to the subject of the audio file. Consider for further explanation, an audio file of an advertisement for a clothing store. The playback time of the audio file corresponding with the word “pants” may be associated with an audio hyperlink to a pants manufacturer. Playing an audio indication of the existence of the audio hyperlink informs a user of the existence of the audio hyperlink allowing a user to invoke a user to the pants manufacturer though speech invocation of the URI if a user so desires.

The method of FIG. 4 also includes playing (414) an audio indication (416) of the audio hyperlink (404) at the predetermined playback time (406). Playing (414) an audio indication (416) of the audio hyperlink (404) at the predetermined playback time (406) may be carried out by playing an earcon designed to inform a user of the existence of the audio hyperlink, by pitch-shifting the playback of the audio file at the playback time having the associated audio hyperlink, by phase-shifting the playback of the audio file at the playback time having the associated audio hyperlink or any other way of playing an audio indication of an audio hyperlink tat will occur to those of skill in the art.

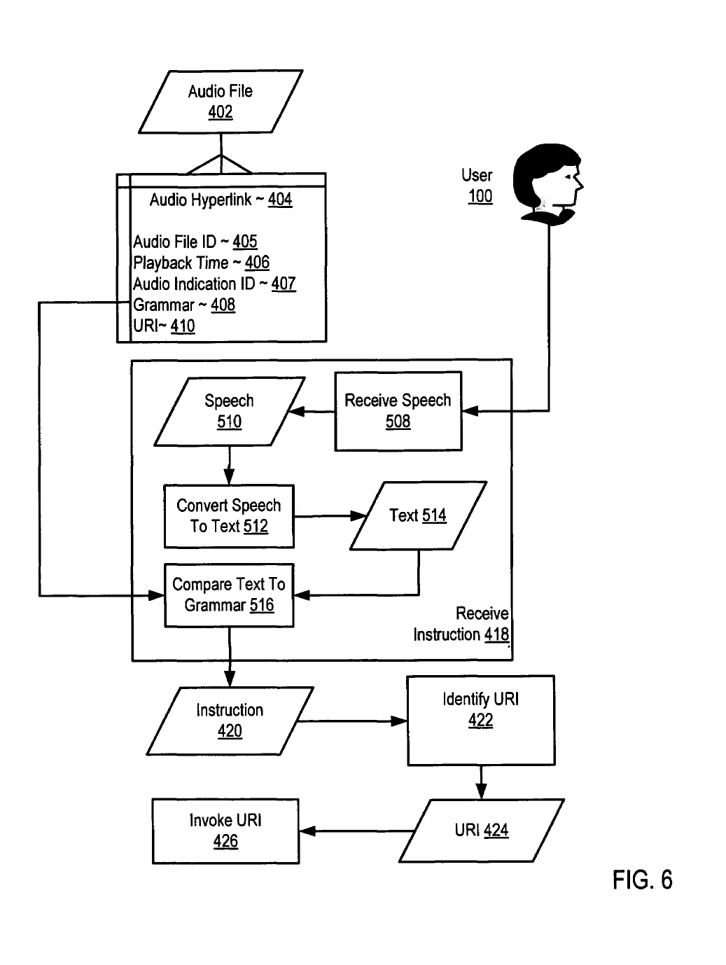

The method of FIG. 4 also includes receiving (418) from a user (100) an instruction (420) to invoke the audio hyperlink (404). Receiving (418) from a user (100) an instruction (420) to invoke the audio hyperlink (404) may be carried out by receiving speech from a user (100); converting the speech to text; and comparing the text to a grammar (408) as discussed below with reference to FIG. 6.). Receiving (418) from a user (100) an instruction (420) to invoke the audio hyperlink (404) may be carried out by receiving an instruction through a user input device such as a keyboard, mouse, GUI input widget or other device as will occur to those of skill in the art.

The method of FIG. 4 also includes identifying (422) a URI (424) associated with the audio hyperlink (404) and invoking (426) the URI (424). Identifying (422) a URI (424) associated with the audio hyperlink (404) may be carried out by retrieving from an audio hyperlink data structure a URI. Invoking (426) the URI (424) makes available the resource or resources referenced by the audio hyperlink.

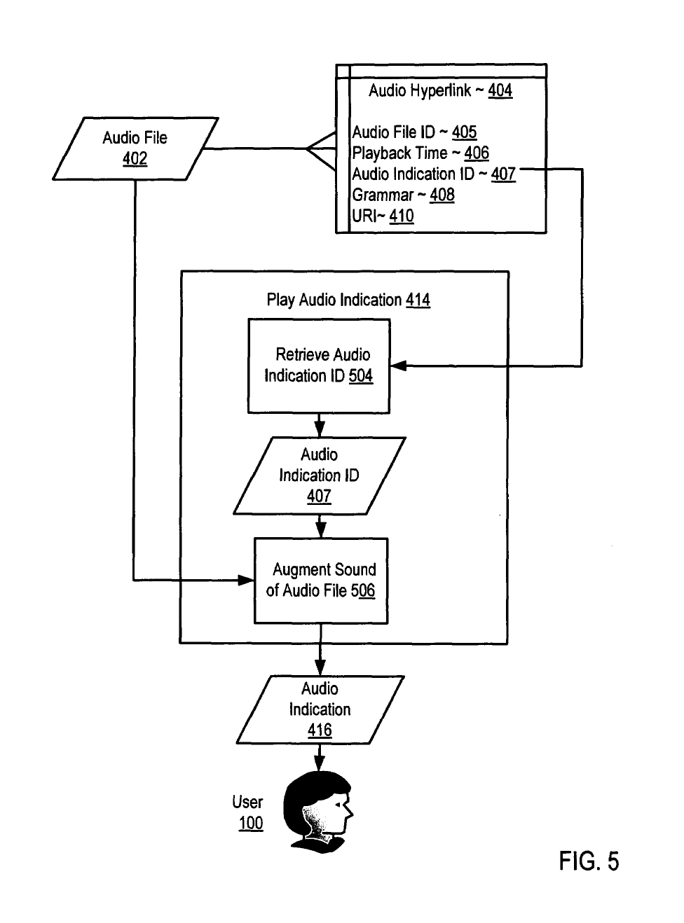

As discussed above, audio file players may be capable of supporting more than one type of audio indication designed to inform a user of the existence of an audio hyperlink. For further explanation, FIG. 5 sets forth a flow chart illustrating an exemplary method for playing an audio indication of an audio hyperlink. In the method of FIG. 5, playing (414) an audio indication (416) of the audio hyperlink (404) includes retrieving (504) from an audio hyperlink data structure (404) an audio indication ID (407) identifying an audio indication of the audio hyperlink (404). An audio indication ID may identify a particular type of audio indication such as for example an earcon, an instruction to phase-shift or pitch-shift the playback of the audio file at the associated playback time or an audio indication ID may identify a particular audio indication of an audio hyperlink such as one of a plurality of supported earcons.

Playing (414) an audio indication (416) of the audio hyperlink (404) according to the method of FIG. 5 also includes augmenting (506) the sound of the audio file (402) in accordance with the audio indication ID (407). Augmenting (506) the sound of the audio file (402) in accordance with the audio indication ID (407) may be carried out by phase-shifting the playback of the audio file at the associated playback time, pitch-shifting the playback of the audio file at the associated playback time, or other ways of changing the normal playback of the audio file at the predetermined playback time. Augmenting (506) the sound of the audio file (402) in accordance with the audio indication ID (407) may also be carried out by adding an earcon such as ring or other sound to the playback of the audio file.

As discussed above, audio hyperlinks are typically invoked by speech instructions from a user. For further explanation, therefore, FIG. 6 sets forth a flow chart illustrating an exemplary method for receiving from a user an instruction to invoke the audio hyperlink that includes receiving (508) speech (510) from a user (100) and converting (512) the speech (510) to text (514). Receiving (508) speech (510) from a user (100) and converting (512) the speech (510) to text (514) may be carried out by a speech synthesis engine in an audio file player supporting audio hyperlinking according to the present invention. Examples of such speech synthesis modules include, for example, IBM's ViaVoice Text-to-Speech, Acapela Multimedia TTS, AT&T Natural Voices™ Text-to-Speech Engine, and other speech synthesis modules as will occur to those of skill in the art.

The method of FIG. 6 also includes comparing (516) the text (514) to a grammar (408). As discussed above, a grammar is a collection of one or more keywords that are recognized by an audio player supporting audio files with audio hyperlinks that when received trigger the invocation of URI for the audio hyperlink. Text conversions of speech instructions matching keywords in the grammar are recognized as instructions to invoke the audio hyperlink.

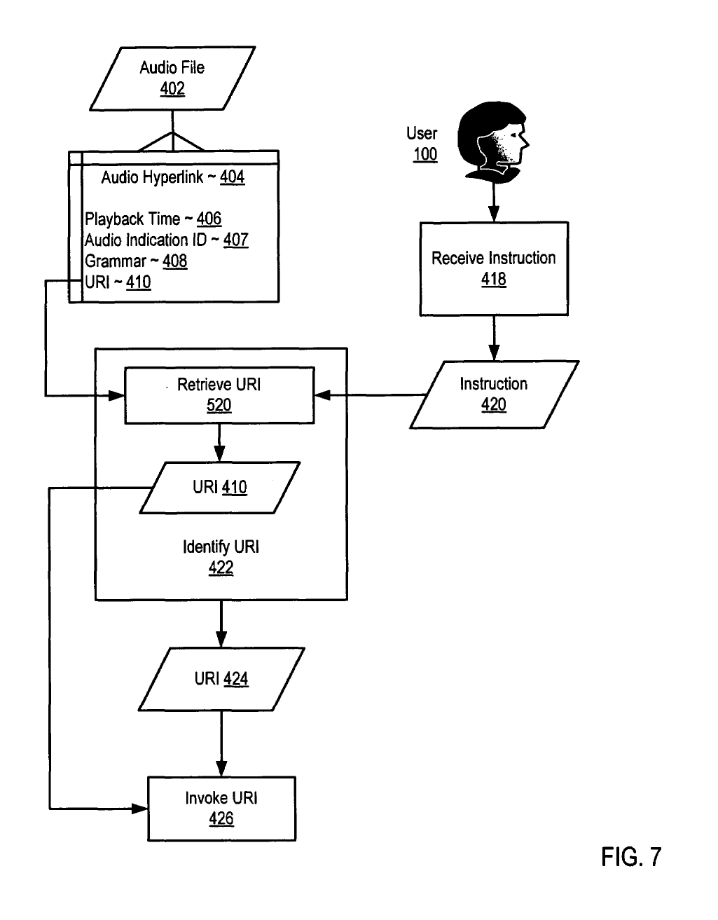

As discussed above, invoking an audio hyperlink is typically carried out by invoking a URI to access a resource referenced by the audio hyperlink. For further explanation, FIG. 7 sets forth a flow chart illustrating an exemplary method for identifying (422) a URI (424) associated with the audio hyperlink (404). Identifying (422) a URI (424) associated with the audio hyperlink (404) according to the method of FIG. 7 includes retrieving (520) from a data structure a URI (410) in dependence upon an instruction (420). Upon receiving an instruction (420) to invoke the audio hyperlink (404), the method of FIG. 7 continues by retrieving from an audio hyperlink data structure (404) the URI associated with the audio hyperlink and requesting access to the resource identified by the URI.

The use of an audio hyperlink data structure is for explanation and not for limitation. In fact, audio hyperlinks may be implemented in a number of ways. Audio hyperlinks may also be implemented through an improved anchor element which is a markup language element. Such an anchor element may be improved to invoke audio hyperlinks. Consider for further explanation the following exemplary anchor element improved to implement an audio hyperlink:

<audioHyperlink href=\\SrvrX\ResourceY playBackTime=00:08:44:44
file=someFile.mp3 grammar ID = grammar123>
Some_Audio_Sound_ID
</audioHyperlink>

This example anchor element includes a start tag <audioHyperlink>, and end tag </audioHyperlink>, which is an href attribute that identifies the target of the audio hyperlink as a resource named ‘ResourceY’ on a web server named ‘SrvrX,’ and an audio anchor. The “audio anchor” is an audio indication of the existence of the audio hyperlink the identification of which is set forth between the start tag and the end tag. That is, in this example, the anchor is an audio sound identified by the identification “Some_Auido_Sound_ID.” Such an audio indication when played is designed to make a user aware of the audio hyperlink. The anchor element also identifies a palyback time of 00:08:44 in file someFile.mp3 as the playback time for playing the audio indication and identifies grammar ID=grammar123 as a grammar including keywords for speech invocation of the audio hyperlink.

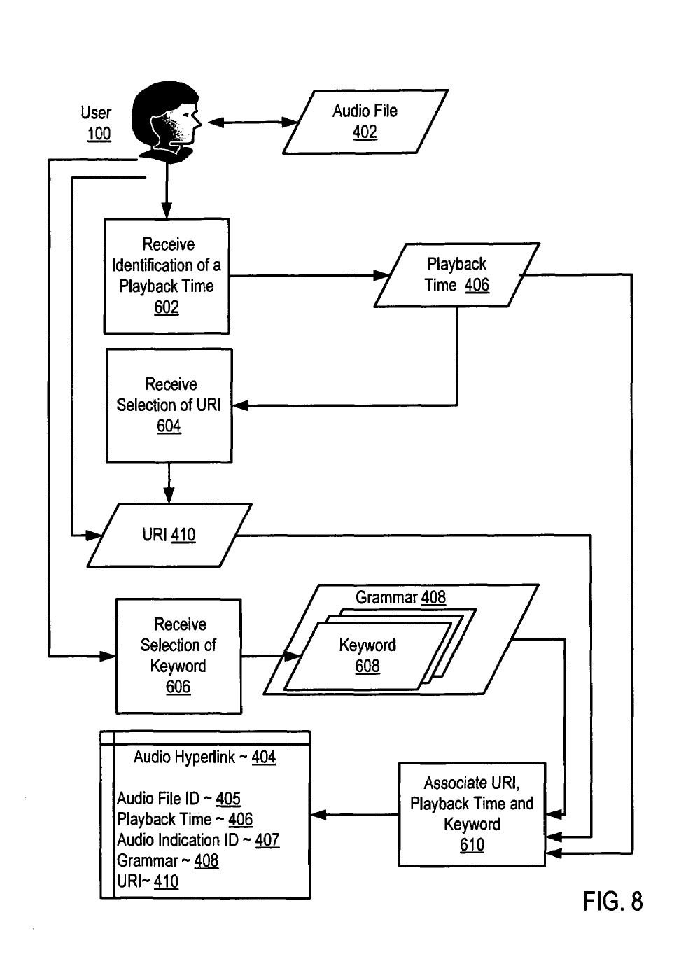

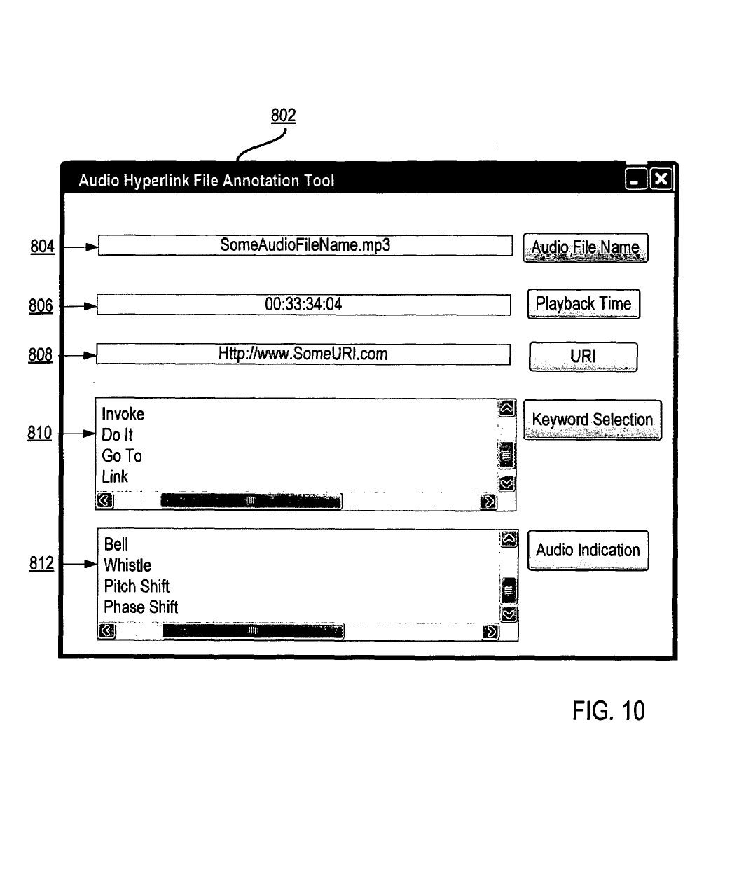

Audio hyperlinks advantageously provide added functionality to audio files allowing users to access additional resources through invoking the audio hyperlinks. To provide users with those additional resources audio files may be annotated with an audio hyperlink. For further explanation, FIG. 8 sets forth a flow chart illustrating an exemplary method for annotating an audio file with an audio hyperlink. The method of FIG. 8 includes receiving (602) an identification of a playback time (406) in an audio file (402) to associate with an audio hyperlink. Receiving an identification of a playback time in an audio file to have an associated audio hyperlink may include receiving a user instruction during the recording of the audio file. Receiving (602) an identification of a playback time (406) in an audio file (402) in such cases may be carried out by receiving a user instruction through an input devices, such as for example buttons on an audio file recorder to indicate a playback time for associating an audio hyperlink. Receiving (602) an identification of a playback time (406) in an audio file (402) for an associated audio hyperlink may also be carried out through the use of a tool such as an audio hyperlink file annotation tool on a computer such as the audio hyperlink file annotation tool discussed below with reference to FIG. 10.

Receiving an identification of a playback time in an audio file to associate with an audio hyperlink may also include receiving a user instruction after the recording of the audio file. Receiving (602) an identification of a playback time (406) in an audio file (402) to associate with an audio hyperlink in such cases may be facilitated by use of a tool running on a computer such as the audio hyperlink file annotation tool discussed below with reference to FIG. 10. Such tools may include input widgets designed to receive from a user an identification of a playback time to associate with an audio hyperlink.

The method of FIG. 8 also includes receiving (604) a selection of a URI (410) identifying a resource to be accessed upon the invocation of the audio hyperlink. Receiving (604) a selection of a URI (410) identifying a resource to be accessed upon the invocation of the audio hyperlink may be carried out by use of a tool running on a computer such as the audio hyperlink file annotation tool discussed below with reference to FIG. 10. Such tools may include input widgets designed to facilitate a users entry of a URI identifying a resource to be accessed upon invoking the audio hyperlink.

The method of FIG. 8 also includes receiving (606) a selection of one or more keywords (608) for invoking the audio hyperlink. Receiving (606) a selection of one or more keywords (608) for invoking the audio hyperlink may be carried out by use of a tool running on a computer such as the audio hyperlink file annotation tool discussed below with reference to FIG. 10. Such tools may include input widgets designed to facilitate a users entry of one or more keywords creating a grammar for invoking an audio hyperlink.

The method of FIG. 8 also includes associating (610) with the playback time (406) in the audio file (402) the URI (410), and the one or more keywords (608). Associating (610) with the playback time (406) in the audio file (402) the URI (410) and the one or more keywords (608) may be carried out by creating an audio hyperlink data structure (404) including an identification of the playback time (406), a grammar (408), and the URI (410). As discussed above, an audio hyperlink data structure (404) is a data structure available to an audio file player that supports audio hyper linking according to the present invention containing information useful in invoking an audio hyperlink. The audio hyperlink data structure (404) of FIG. 4 includes an audio file ID (405) uniquely identifying the audio file having an associated audio hyperlink. The audio hyperlink data structure (404) of FIG. 4 also includes a playback time (406) identifying a playback time in the audio file having an associated audio hyperlink. The Audio hyperlink data structure of FIG. 8 includes an audio indication ID (407) uniquely identifying the audio indication for the audio hyperlink. The audio hyperlink data structure (404) of FIG. 8 includes a grammar (408) including keywords for speech invocation of the audio hyperlink. The audio hyperlink data structure (404) of FIG. 8 also includes a URI (410) identifying a resource referenced by the audio hyperlink.

Associating (610) with the playback time (406) in the audio file (402) the URI (410), and the one or more keywords (608) may also be carried out through an improved markup language anchor element. Such an anchor element may be improved to invoke audio hyperlinks as discussed above.

Associating (610) with the playback time (406) in the audio file (402) the URI (410) and the one or more keywords (608) may also include creating an audio hyperlink markup document including an identification of the playback time, a grammar, and a URI. An audio hyperlink markup document includes any collection of text and markup associating with a playback time in audio file and URI and one or more keywords for invoking the audio hyperlink. For further explanation, consider the following exemplary audio hyperlink markup document:

```
<audio hyperlink markup document>
    <Audio Hyperlink ID = 1>
        <Playback Time>
            00:03:14:45
        <Playback Time>
        <Grammar>
        “Play link” “Invoke” “Go to Link” “Play”
        </Grammar>
        <URI>
        http://www.someURI.com
        </URI>
    </Audio Hyperlink ID = 1>
    <Audio Hyperlink ID = 2>
        <Playback Time>
            00:14:02:33
        <Playback Time>
        <Grammar>
        “Go” “Do It” Play link” “Invoke” “Go to Link” “Play”
        </Grammar>
        <URI>
        http://www.someOtherWebSite.com
        </URI>
    </Audio Hyperlink ID = 1>
    ...
</audio hyperlink markup document>
```

The audio hyperlink markup document in the example above includes a plurality of audio hyperlinks including two audio hyperlinks identified as audio hyperlink ID=1 and audio hyperlink ID=2 by the tags <Audio Hyperlink ID=1></Audio Hyperlink ID=1>and <Audio Hyperlink ID=2></Audio Hyperlink ID=2>. Audio hyperlink ID=1 is an audio hyperlink associated with playback time of 00:03:14:45 in an audio file. The audio hyperlink references the URI ‘http://www.someURI.com’ which may be invoked by use of the following speech keywords “Play link” “Invoke” “Go to Link” “Play” that make up a grammar for speech invocation of the audio hyperlink.

Audio hyperlink ID=2 is an audio hyperlink associated with playback time of 00:14:02:33 in an audio file. The audio hyperlink references a URI ‘http://www.someOtherWebSite.com’ which may be invoked by use of the following speech keywords “Go” “Do It” Play link” “Invoke” “Go to Link” “Play” in an associated grammar for speech invocation of the audio hyperlink.

The exemplary audio hyperlink markup document is for explanation and not for limitation. In fact, audio hyperlink markup documents may be implemented in many forms and all such forms are well within the scope of the present invention.

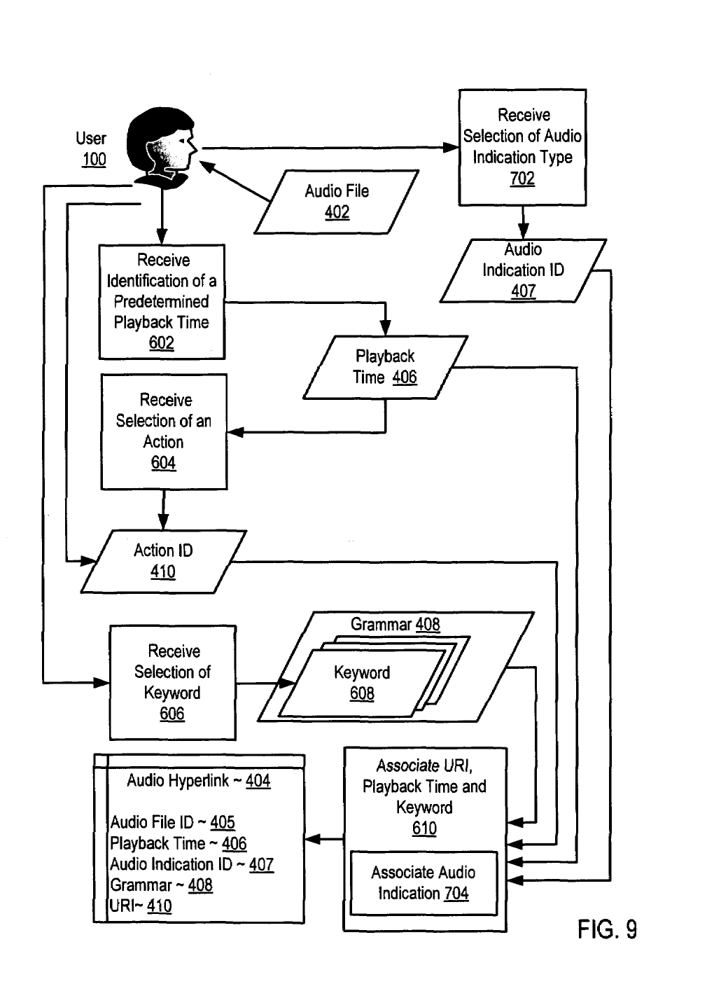

For further explanation, FIG. 9 sets forth a flow chart illustrating another exemplary method for annotating an audio file with an audio hyperlink. The method of FIG. 9 is similar to the method of FIG. 8 in that the method of FIG. 9 includes receiving (602) an identification of a playback time (406) in an audio file (402) to associate with an audio hyperlink; receiving (604) a selection of a URI (410) identifying a resource to be accessed upon the invocation of the audio hyperlink; receiving (606) a selection of one or more keywords (608) for invoking the audio hyperlink; and associating (610) with the playback time (406) in the audio file (402) the URI (410), and the one or more keywords (608). The method of FIG. 9, however, also includes receiving (702) a selection of an associate audio indication (704) for identifying of the existence of the audio hyperlink (404) during playback of the audio file (402).

In the method of FIG. 9, associating (610) with the playback time (406) in the audio file (402) the URI (410), and the one or more keywords (608) also includes associating with the playback time (406) the audio indication (704). Associating with the playback time (406) the audio indication (704) may be carried out through the use of an audio hyperlink data structure, an improved anchor element, an audio hyperlink markup document and in other ways as will occur to those of skill in the art.

As discussed above, annotating an audio file with an audio hyperlink may be facilitated by use of audio hyperlink GUI screens. For further explanation, therefore FIG. 10 sets forth a line drawing of an audio hyperlink file annotation tool (802) useful in annotating an audio file with an audio hyperlink according to the present invention. The audio hyperlink file annotation tool (802) of FIG. 10 includes a GUI input widget (804) for receiving a user selection of an audio file to be annotated by inclusion of an audio hyperlink. In the example of FIG. 10, the audio file called ‘SomeAudioFileName.mp3’ has been selected for annotation to include an audio hyperlink.

The audio hyperlink file annotation tool (802) of FIG. 10 includes a GUI input widget (806) for receiving a user selection of playback time in the audio file to have an associated audio hyperlink. In the example of FIG. 10, the audio file called ‘SomeAudioFileName.mp3’ has been selected for annotation to include an audio hyperlink at playback time 00:00:34:04.

The audio hyperlink file annotation tool (802) of FIG. 10 includes a GUI input widget (808) for receiving a user selection of a URI identifying a resource accessible by invoking the audio hyperlink. In the example of FIG. 10, the URI ‘http:///www.someURI.com’ is selected associated with the audio hyperlink.

The audio hyperlink file annotation tool (802) of FIG. 10 also includes a GUI selection widget (810) for receiving a user selection of one or more keywords creating a grammar for speech invocation of the audio hyperlink. In the example of FIG. 10, available predetermined keywords include ‘invoke,’ ‘Do It,’ ‘Go to,’ and ‘Link.’ The pre-selected keywords are presented in the example of FIG. 10 for explanation and not for limitation. In fact, any keywords may be associated with an audio hyperlink either by providing a list of such words for user selection or providing for user input of keywords as will occur ot those of skill in the art.

The audio hyperlink file annotation tool (802) of FIG. 10 also includes a GUI selection widget (812) for receiving a user selection of an audio indication identifying to a user the existence of the audio hyperlink. In the example of FIG. 10, possible audio indications include a bell sound, a whistle sound, pitch-shifting the playback and phase-shifting the playback of the audio file.

Exemplary embodiments of the present invention are described largely in the context of a fully functional computer system for invoking an audio hyperlink. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for annotating an audio file with an audio hyperlink, the method comprising:
receiving an identification of a playback time in an audio file to associate with an audio hyperlink;
receiving a selection of a Uniform Resource Identifier (‘URI’) identifying a resource to be accessed upon the invocation of the audio hyperlink;
receiving a selection of one or more keywords for invoking the audio hyperlink; and
associating with the playback time in the audio file the URI, and the one or more keywords.

2. The method of claim 1 further comprising receiving a selection of an audio indication type for identifying of the existence of the audio hyperlink during playback of the audio file.

3. The method of claim 2 wherein associating with the playback time in the audio file the URI, and the one or more keywords further comprises associating with the playback time the audio indication.

4. The method of claim 1 wherein receiving an identification of a playback time in an audio file to associate with an audio hyperlink further comprises receiving a user instruction during the recording of the audio file.

5. The method of claim 1 wherein receiving an identification of a playback time in an audio file to associate with an audio hyperlink further comprises receiving a user instruction after the recording of the audio file.

6. The method of claim 1 wherein associating with the playback time in the audio file the URI and the one or more keywords further comprises creating an audio hyperlink data structure including an identification of the playback time, a grammar, and an URI.

7. The method of claim 1 wherein associating with the playback time in the audio file the URI and the one or more keywords further comprises creating an audio hyperlink markup document including an identification of the playback time, a grammar, and a URI.

8. The method of claim 1 wherein associating with the playback time in the audio file the URI and the one or more keywords further comprises creating an anchor element including an identification of the playback time, a grammar, and a URI.

9. A system for annotating an audio file with an audio hyperlink, the system comprising a computer processor, a computer memory operatively coupled to the computer processor, the computer memory having disposed within it computer program instructions capable of:
receiving an identification of a playback time in an audio file to associate with an audio hyperlink;
receiving a selection of a Uniform Resource Identifier (‘URI’) identifying a resource to be accessed upon the invocation of the audio hyperlink;
receiving a selection of one or more keywords for invoking the audio hyperlink; and
associating with the playback time in the audio file the URI, and the one or more keywords.

10. The system of claim 9 the computer memory also having disposed within it computer program instructions capable of receiving a selection of an audio indication type for identifying of the existence of the audio hyperlink during playback of the audio file.

11. The system of claim 10 wherein the computer memory also has disposed within it computer program instructions capable of associating with the playback time the audio indication.

12. The system of claim 9 wherein the computer memory also has disposed within it computer program instructions capable of receiving a user instruction during the recording of the audio file.

13. The system of claim 9 wherein the computer memory also has disposed within it computer program instructions capable of receiving a user instruction after the recording of the audio file.

14. The system of claim 9 wherein the computer memory also has disposed within it computer program instructions capable of creating an audio hyperlink data structure including an identification of the playback time, a grammar, and an URI.

15. The system of claim 9 wherein the computer memory also has disposed within it computer program instructions capable of creating an audio hyperlink markup document including an identification of the playback time, a grammar, and a URI.

16. The system of claim 9 wherein the computer memory also has disposed within it computer program instructions capable of creating an anchor element including an identification of the playback time, a grammar, and a URI.

17. A computer program product for annotating an audio file with an audio hyperlink, the computer program product embodied on a computer-readable medium, the computer program product comprising:
computer program instructions for receiving an identification of a playback time in an audio file to associate with an audio hyperlink;
computer program instructions for receiving a selection of a Uniform Resource Identifier (‘URI’) identifying a resource to be accessed upon the invocation of the audio hyperlink;
computer program instructions for receiving a selection of one or more keywords for invoking the audio hyperlink; and
computer program instructions for associating with the playback time in the audio file the URI, and the one or more keywords.

18. The computer program product of claim 17 wherein computer program instructions for associating with the playback time in the audio file the URI and the one or more keywords further comprise computer program instructions for creating an audio hyperlink data structure including an identification of the playback time, a grammar, and an URI.

19. The computer program product of claim 17 wherein computer program instructions for associating with the playback time in the audio file the URI and the one or more keywords further comprise creating an audio hyperlink markup document including an identification of the playback time, a grammar, and a URI.

20. The computer program product of claim 17 wherein computer program instructions for associating with the playback time in the audio file the URI and the one or more keywords further comprise creating an anchor element including an identification of the playback time, a grammar, and a URI.
